(19) United States
(12) Patent Application Publication
(10) Pub. No.: US 2025/0176629 A1
(43) Pub. Date: Jun. 5, 2025

(54) RESISTIVE HEATING ELEMENT FOR FOR AN AEROSL PROVISION DEVICE

(71) Applicant: NICOVENTURES TRADING LIMITED, London (GB)

(72) Inventor: Michael THOMAS, London (GB)

(21) Appl. No.: 18/842,495

(22) PCT Filed: Mar. 1, 2023
(86) PCT No.: PCT/EP2023/055232

§ 371 Date: Aug. 29, 2024

(30) Foreign Application Priority Data
Mar. 2, 2022 (GB) 2202911.0

(51) Int. Cl. A24F 40/46; A24F 40/60; H05B 3/26

(52) U.S. Cl. CPC A24F 40/46; A24F 40/60; H05B 3/26

(57) ABSTRACT

A resistive heating element for an aerosol provision device including a substrate and one or more electrically conductive tracks provided on the substrate, wherein at least one of the one or more electrically conductive tracks includes a portion wherein the width or cross-sectional area of the one or more electrically conductive tracks is reduced in order to create an enhanced heating region, wherein the enhanced heating region is arranged to cause a visual indication to be generated on an aerosol generating article at the end of a session of use.

### RELATED APPLICATIONS

The present application is a National Phase entry of PCT Application No. PCT/EP2023/055232 filed Mar. 1, 2023, which claims priority to GB Application No. 2202911.0 filed Mar. 2, 2022, each of which is hereby incorporated by reference in their entirety.

### TECHNICAL FIELD

The present invention relates to a resistive heating element for an aerosol provision device, an aerosol provision device, an aerosol generating system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation.

It is known to use a resistive heater to heat an aerosol generating article.

Conventional aerosol provision devices comprise a cylindrical heating chamber into which a rod shaped consumable is inserted.

One problem with known aerosol provision devices is that after a session of use a user may remove a spent aerosol generating article from the aerosol provision device. However, the user may find it difficult to distinguish between an unused aerosol generating article and a spent aerosol generating article.

It is desired to provide an improved aerosol provision device.

### SUMMARY

According to an aspect there is provided a resistive heating element for an aerosol provision device comprising:
a substrate; and
one or more conductive tracks provided on the substrate;
wherein at least one of the one or more electrically conductive tracks includes a portion wherein the width or cross-sectional area of the one or more electrically conductive tracks is reduced in order to create an enhanced heating region, wherein the enhanced heating region is arranged to cause a visual indication to be generated on an aerosol generating article at the end of a session of use.

According to various embodiments a resistive heating element is disclosed having a conductive track which forms an enhanced heating region. The enhanced heating region is intended to generate a visual indication (e.g. charring) on an aerosol generating article at the end of a session of use in order to indicate to a user that the aerosol generating article is spent.

In particular, the resistive heating element according to various embodiments is beneficial in that it enables a user after a session of use to distinguish between an unused aerosol generating article and a spent aerosol generating article.

Optionally, the visual indication may comprise charring. It will be understood that charring may involve partial burning or blackening of a portion of the aerosol generating article.

Optionally, the visual indication may comprise a permanent change of color of, for example, a thermochromic region provided on the aerosol generating article.

Optionally, the one or more electrically conductive tracks may comprise a first portion having a first width W1 and a second portion having a second width W2, wherein W2<W1.

Optionally, W1/W2 is in the range 1.1-1.5, 1.5-2.0, 2.0-2.5, 2.5-3.0, 3.0-3.5, 3.5-4.0, 4.0-4.5,4.5-5.0 or >5.0.

Optionally, the one or more electrically conductive tracks comprise a first portion having a first cross-sectional area A1 and a second portion having a second cross-sectional area A2, wherein A2<A1.

Optionally, A1/A2 is in the range 1.1-1.5, 1.5-2.0, 2.0-2.5, 2.5-3.0, 3.0-3.5, 3.5-4.0, 4.0-4.5,4.5-5.0 or >5.0.

Optionally, the substrate comprises an electrical insulator.

Optionally, the substrate comprises zirconia (ZrO₂).

Optionally, the one or more electrically conductive tracks comprise a metal or a metallic alloy.

Optionally, the metal or metallic alloy comprises a silver palladium (AgPa) alloy.

Optionally, the one or more electrically conductive tracks form one or more loops.

Optionally, the resistive heating element further comprises a first electrode connected to one of the electrically conductive tracks and a second electrode connected to one of the electrically conductive tracks.

Optionally, the one or more electrically conductive tracks are deposited or printed onto the substrate and the tracks and the substrate are then sintered.

Optionally, the resistive heating element further comprises a glass or protective coating applied to the one or more electrically conductive tracks.

According to another aspect there is provided an aerosol provision device comprising a resistive heating element as described above.

According to another aspect there is provided an aerosol generating system comprising:
an aerosol provision device as described above; and
an aerosol generating article.

According to another aspect there is provided a method of generating an aerosol comprising:
inserting an aerosol generating article into an aerosol provision device comprising a resistive heating element, wherein the resistive heating element comprises a substrate and one or more electrically conductive tracks provided on the substrate, wherein at least one of the one or more electrically conductive tracks includes a portion wherein the width or cross-sectional area of the one or more electrically conductive tracks is reduced in order to create an enhanced heating region; and
operating the aerosol provision device so that the enhanced heating region causes a visual indication to be generated on an aerosol generating article at the end of a session of use.

### BRIEF DESCRIPTION OF THE DRAWINGS

Various embodiments will now be described, by way of example only, and with reference to the accompanying drawings in which:

FIG. 1 shows an aerosol provision device located within a charging unit according to an embodiment;

FIG. 2 shows a cross-sectional view of an aerosol provision device located within a charging unit;

FIG. 3 shows a resistive heating element according to an embodiment comprising two copper tracks connected to a loop arrangement of electrically conductive tracks, wherein the loop arrangement has a reduced width portion which creates an enhanced heating region which is arranged to cause a visual indication to be generated on an aerosol generating article at the end of a session of use;

FIG. 4 shows a resistive heating element according to an embodiment connected to a printed circuit board (“PCB”) wherein the resistive heating element comprises electrically conductive tracks which have a reduced width portion which creates an enhanced heating region which is arranged to cause a visual indication to be generated on an aerosol generating article at the end of a session of use;

FIG. 5 shows a perspective view of the resistive heating element according to an embodiment showing how the resistive heating element may be shaped to form a blade heating element and wherein in use an aerosol generating article is forced onto the blade heating element so that the heating element is inserted into the aerosol generating article; and

FIG. 6 shows another view of the resistive heating element according to an embodiment and shows how the resistive heating element includes a reduced width portion which creates an enhanced heating region which is arranged to cause a visual indication to be generated on an aerosol generating article at the end of a session of use.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise one or more active substances and/or flavors, one or more aerosol-former materials, and optionally one or more other functional material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

Various embodiments will now be described in more detail.

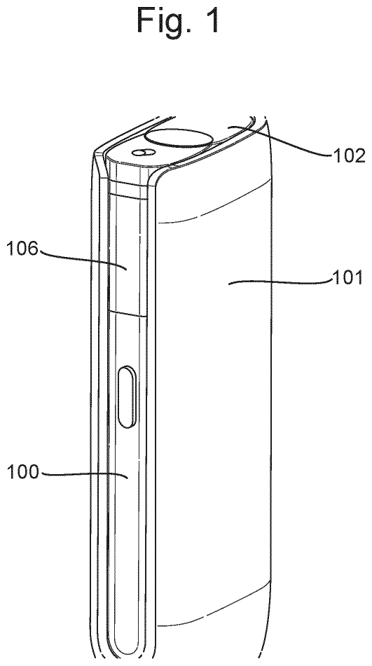

FIG. 1 shows an aerosol provision device 100 according to an embodiment shown located within an elongate cavity of a charging unit 101. The charging unit 101 may comprise a power source (not shown). The power source may include, for example, a battery (single-use or rechargeable), a rechargeable super capacitor, a rechargeable solid-state battery (SSB), a rechargeable lithium-ion battery (LiB) or the like, a hermetically sealed battery, a pouch cell battery or some combination thereof.

The aerosol provision device 100 may be left in the charging unit 101 for a predetermined time in order to allow sufficient charging of the aerosol provision device 100. For example, the charging unit 101 may be arranged to charge the aerosol provision device 100 to full charge in a time of <10 mins, 10-20 mins, 20-30 mins, 30-40 mins, 40-50 mins, 50-60 mins or >60 mins.

The charging unit 101 and/or the aerosol provision device 100 may optionally have an indicator to give a visual or other representation to the user of the charging level of the aerosol provision device 100. Additionally, there may be a separate indicator to give a visual representation of the charge level of the charging unit 101. The current charge level of the aerosol provision device 100 and/or the charging unit 101 may be determined by control means disposed in the aerosol provision device 100 and/or the charging unit 101.

The visual indicator may comprise one or more light-emitting diodes (LEDs). However, other embodiments are contemplated where the visual indicator may be replaced by an audio indicator (e.g. a speaker) or a haptic indicator.

The aerosol provision device 100 may comprise an outer housing which may have a tubular and/or cylindrical shape. However, other embodiments are envisaged wherein the aerosol provision device 100 may take other desired forms e.g. the aerosol provision device 100 may be box shaped. According to an embodiment the outer housing of the aerosol provision device 100 may comprise an electrical insulator and may, for example, be formed of polyetheretherketone (“PEEK”).

According to an embodiment the distal end of the aerosol provision device 100 may comprise one or more orientation features and/or one or more magnets for securing the distal end of the aerosol provision device 100 to a base portion of the charging unit 101.

The aerosol provision device 100 may be inserted into the cavity of the charging unit 101 in order to recharge the aerosol provision device 100 by receiving electrical power from the charging unit 101. The charging unit 101 may comprise an internal battery to provide electrical power to the aerosol provision device 100. The charging unit 101 may also be connected to an external source of electrical power.

The charging unit 101 may comprise a lid or cover 102 which may be slid by a user between an open and closed position. The lid or cover 102 is provided at the entrance to the cavity which is provided within the charging unit 101 and which is configured to receive the aerosol provision device 100.

The aerosol provision device 100 includes an aerosol generator for generating aerosol from aerosol generating material. According to an embodiment the aerosol provision device 100 comprises a resistive heater for heating an aerosol generating article.

When the lid or cover 102 is in the open position an opening to the cavity is exposed thereby enabling a user to either remove the aerosol provision device 100 from the charging unit 101 (in order to use the aerosol provision device 100) or alternatively to insert the aerosol provision device 100 into the charging unit 101 (in order to charge the aerosol provision device 100).

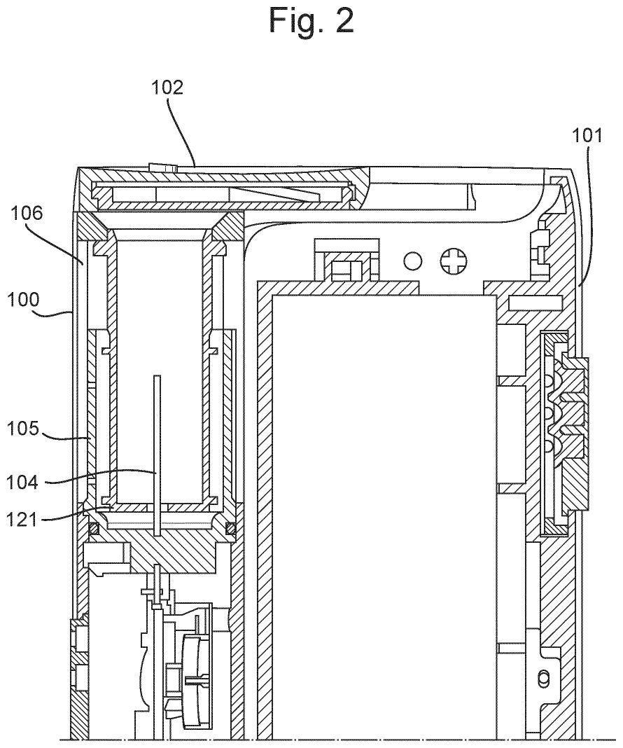

FIG. 2 shows a cross-sectional view showing the aerosol provision device 100 located or docked within the charging unit 101. The aerosol provision device 100 comprises a main housing 105 wherein a resistive heating element 104 projects within the main housing 105. The aerosol provision device 100 may further comprise a removable cap 106 which may be magnetically retained to the main housing 105.

A consumable cartridge 120 is attached to the removable cap 106 and comprises a tubular housing having a base portion 121. The base portion 121 of the consumable cartridge 120 has an aperture and the resistive heating element 104 is arranged to project through the aperture. An aerosol generating article may be inserted into the aerosol provision device 100 by inserting the aerosol generating article through an opening in the removable cap 106 and then inserting the aerosol generating article into the consumable cartridge 120 and onto the heating element 104. The heating element 104 may have a blade like profile and in use an aerosol generating article may be forced onto the heating element 104 so that the blade like profile of the heating element 120 inserts into a distal end of the aerosol generating article. The heating element 104 is arranged to internally heat the aerosol generating article.

At the end of a session of use, when an aerosol generating article has been consumed, the removable cap 106 and attached consumable cartridge 120 may then be detached from the main housing 105. It will be understood that the process of detaching the removable cap 106 and attached consumable cartridge 120 will have the effect that the base portion 121 of the consumable cartridge 120 will contact a bottom face of the aerosol generating article. As the removable cap 106 and attached consumable cartridge 120 are withdrawn, then the base portion 121 of the consumable cartridge 120 will contact the distal end of the aerosol generating article and will result in the aerosol generating article being pulled off or otherwise removed from the heating element 104.

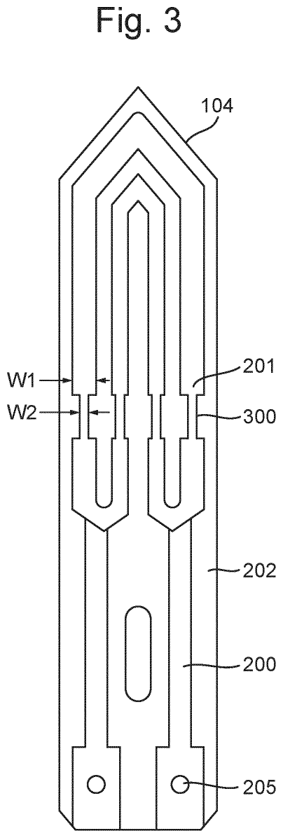

FIG. 3 shows a resistive heating element 104 according to an embodiment comprising copper tracks 201 provided on a base substrate 202. According to an embodiment the base substrate 202 may comprise zirconia (ZrO₂). The tracks 201 may be formed into a looped arrangement of tracks 201 and according to an embodiment the tracks 201 may have a reduced width and/or reduced cross-sectional area portion 300. The reduced width and/or reduced cross-sectional area portion 300 may comprise a portion of the tracks wherein the width and/or cross-sectional is reduced relative to the remaining portion of the tracks. According to various embodiments this creates an enhanced heating region.

As shown in FIG. 3, according to an embodiment the one or more electrically conductive tracks 201 may comprise a first portion having a first width W1 and a second portion having a second width W2, wherein W2<W1. Optionally, W1/W2 is in the range 1.1-1.5, 1.5-2.0, 2.0-2.5,2.5-3.0, 3.0-3.5, 3.5-4.0, 4.0-4.5, 4.5-5.0 or >5.0.

According to an embodiment the enhanced heating region may be arranged to cause a visual indication to be generated on an aerosol generating article at the end of a session of use. For example, the heating element 104 may be arranged to deliberately cause charring to occur to a portion of an aerosol generating article in order to indicate to a user after a session of use has been completed than the aerosol generating article has been consumed or is otherwise spent.

Other embodiments are contemplated wherein the aerosol generating article may comprise a thermochromic region. According to an embodiment the enhanced heating region may be arranged to cause a permanent change of color of at least a portion of the thermochromic region. For example, a thermochromic region provided on an unused aerosol generating article may have a white color and the enhanced heating region may be arranged to cause a change of color of the thermochromic region to, for example, a dark grey or black color (thereby indicating to a user that the aerosol generating article is spent).

The electrically conductive tracks 201 may be formed from, for example, a silver palladium (AgPd) alloy. The electrically conductive tracks 201 may be electrically connected to electrodes 200 which may be formed of copper. As shown in FIG. 3, the electrodes 200 may each include a base connector portion having an aperture 205. Electrical wires may be soldered to the electrodes 200 via the apertures 205.

According to an embodiment the electrically conductive tracks 201 and the electrodes 200 may be printed or deposited onto the substrate 202 and then the substrate 202 and electrically conductive tracks 201 and electrodes 200 may be sintered. For example, according to an embodiment the substrate 202, electrically conductive tracks 201 and electrodes 200 may be heated to a temperature of approx. 700° C.

According to an embodiment a glass coating may be applied to the top surface of the blade heating element 104 in order to provide a protective coating. The application of the glass coating to the heating element 104 may give the heating element 104 a blue appearance. According to an embodiment a glass coating may be applied to one or both sides of the resistive heating element 204 in order to provide a protective coating.

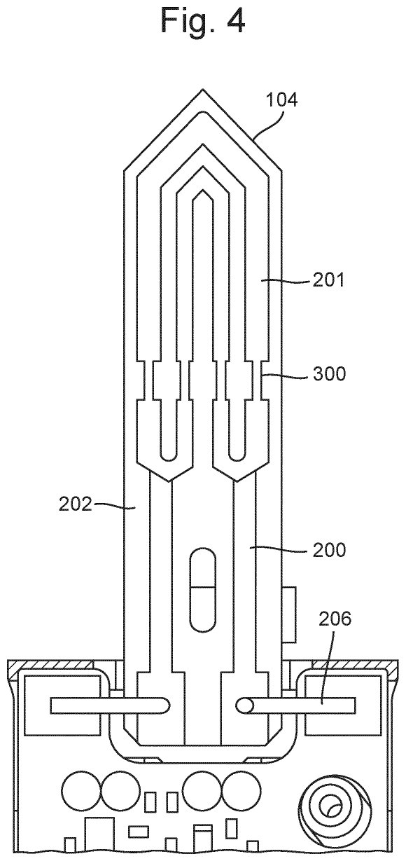

FIG. 4 shows a resistive heating element 104 according to an embodiment wherein the resistive heating element 104 comprises electrically conductive tracks 201 which have a reduced width portion 300 which creates an enhanced heating region which is arranged to cause a visual indication to be generated on an aerosol generating article at the end of a session of use.

The resistive heating element 104 is shown attached to a printed circuit board control unit. One or more electrical wires 206 may connect the control circuit to the electrodes 200 of the heating element 104 in order to provide electrical power to the conductive tracks.

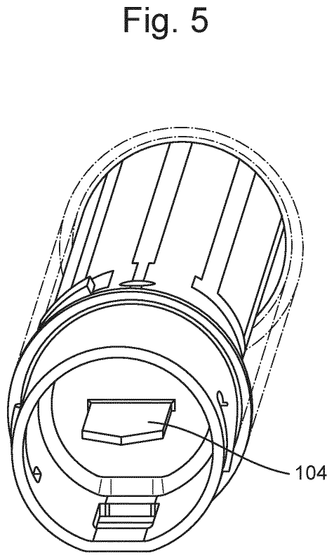

FIG. 5 shows a perspective view of the main housing of an aerosol provision device 100 according to an embodiment and shows a resistive heating element 104 projecting within the main housing of the aerosol provision device.

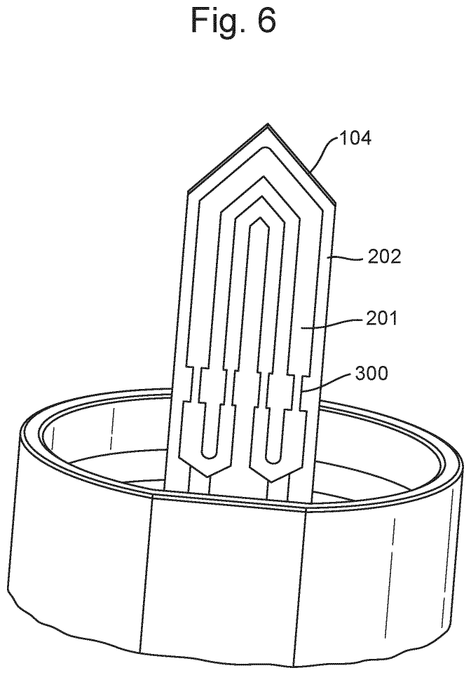

FIG. 6 shows a perspective view of a resistive heating element 104 according to an embodiment. The resistive heating element 104 comprises a substrate 202 with electrically conductive tracks 201 provided on the substrate 202. The electrically conductive tracks 201 have a reduced width portion 300 which creates an enhanced heating region which is arranged to cause a visual indication to be generated on an aerosol generating article at the end of a session of use.

According to various embodiments at least one of one or more electrically conductive tracks 201 provided on a resistive heating element include a portion wherein the width and/or cross-sectional area of the electrically conductive tracks 201 is reduced thereby creating an enhanced heating region. The enhanced heating region is arranged to cause a visual indication to be generated on an aerosol generating article at the end of a session of use.

In particular, the enhanced heating region is arranged to cause charring (i.e. blackening) on a portion of the aerosol generating article at the end of a session of use in order to indicate to a user that the aerosol generating article is spent.

As a result, a user is enabled to differentiate between unused and spent aerosol generating articles.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A resistive heating element for an aerosol provision device comprising:
a substrate; and
one or more electrically conductive tracks provided on the substrate;
wherein at least one of the one or more electrically conductive tracks includes a portion wherein the width or cross-sectional area of the one or more electrically conductive tracks is reduced in order to create an enhanced heating region, wherein the enhanced heating region is arranged to cause a visual indication to be generated on an aerosol generating article at the end of a session of use.

2. A resistive heating element as claimed in claim 1, wherein the visual indication comprises charring.

3. A resistive heating element as claimed in claim 1, wherein the visual indication comprises a permanent change of color of a thermochromic region provided on the aerosol generating article.

4. A resistive heating element as claimed in claim 1, wherein the one or more electrically conductive tracks comprises a first portion having a first width W1 and a second portion having a second width W2, wherein W2<W1.

5. A resistive heating element as claimed in claim 4, wherein W1/W2 is in the range 1.1-1.5, 1.5-2.0, 2.0-2.5, 2.5-3.0, 3.0-3.5, 3.5-4.0, 4.0-4.5, 4.5-5.0 or >5.0.

6. A resistive heating element as claimed in claim 1, wherein the one or more electrically conductive tracks comprise a first portion having a first cross-sectional area A1 and a second portion having a second cross-sectional area A2, wherein A2<A1.

7. A resistive heating element as claimed in claim 6, wherein A1/A2 is in the range 1.1-1.5, 1.5-2.0, 2.0-2.5, 2.5-3.0, 3.0-3.5, 3.5-4.0, 4.0-4.5, 4.5-5.0 or >5.0.

8. A resistive heating element as claimed in claim 1, wherein the substrate comprises an electrical insulator.

9. A resistive heating element as claimed in claim 8, wherein the substrate comprises zirconia (ZrO₂).

10. A resistive heating element as claimed in claim 1, wherein the one or more electrically conductive tracks comprise a metal or a metallic alloy.

11. A resistive heating element as claimed in claim 10, wherein the metal or metallic alloy comprises a silver palladium (AgPa) alloy.

12. A resistive heating element as claimed in claim 1, wherein the one or more electrically conductive tracks form one or more loops.

13. A resistive heating element as claimed in claim 1, further comprising a first electrode connected to one of the electrically conductive tracks and a second electrode connected to one of the electrically conductive tracks.

14. A resistive heating element as claimed in claim 1, wherein the one or more electrically conductive tracks are deposited or printed onto the substrate and the tracks and the substrate are then sintered.

15. A resistive heating element as claimed in claim 1, further comprising a glass or protective coating applied to the one or more electrically conductive tracks.

16. An aerosol provision device comprising a resistive heating element as claimed in claim 1.

17. An aerosol generating system comprising:
an aerosol provision device as claimed in claim 16; and
an aerosol generating article.

18. A method of generating an aerosol comprising:
inserting an aerosol generating article into an aerosol provision device comprising a resistive heating element, wherein the resistive heating element comprises a substrate and one or more electrically conductive tracks provided on the substrate, wherein at least one of the one or more electrically conductive tracks includes a portion wherein the width or cross-sectional area of the one or more electrically conductive tracks is reduced in order to create an enhanced heating region; and
operating the aerosol provision device so that the enhanced heating region causes a visual indication to be generated on an aerosol generating article at the end of a session of use.
